(19) United States
(12) Patent Application Publication
(10) Pub. No.: US 2012/0044613 A1
(43) Pub. Date: Feb. 23, 2012

(54) Electrolyte for lithium ion capacitor and lithium ion capacitor including the same

(75) Inventors: Ji Sung Cho, Gyunggi-do (KR); Sang Kyun Lee, Gyunggi-do (KR); Bae Kyun Kim, Gyunggi-do (KR)

(73) Assignee: SAMSUNG ELECTRO-MECHANICS CO., LTD., Suwon-si (KR)

(21) Appl. No.: 12/929,025

(22) Filed: Dec. 22, 2010

(30) Foreign Application Priority Data
Aug. 18, 2010 (KR) 10-2010-0079986

(51) Int. Cl. H01G 9/155; H01G 9/022; H01G 9/038; C01B 35/00

(52) U.S. Cl. 361/502; 423/276; 252/62.2

(57) ABSTRACT

There are provided an electrolyte for a lithium ion capacitor, and a lithium ion capacitor including the same. The electrolyte includes a lithium salt having divalent anions. The lithium ion capacitor including the electrolyte may have high capacitance and stability, even at high temperatures.

### CROSS-REFERENCE TO RELATED APPLICATIONS

This application claims the priority of Korean Patent Application No. 10-2010-0079986 filed on Aug. 18, 2010, in the Korean Intellectual Property Office, the disclosure of which is incorporated herein by reference.

### BACKGROUND OF THE INVENTION

1. Field of the Invention

The present invention relates to an electrolyte for a lithium ion capacitor and a lithium ion capacitor including the same, and more particularly, to an electrolyte for a lithium ion capacitor which has high capacitance and stability even at high temperatures, and lithium ion capacitor including the same.

2. Description of the Related Art

In various electronic products such as information communications devices and the like, a stable energy supply is an important factor. In general, such a function is performed by a capacitor. Namely, the capacitor serves to collect electricity in the circuits of an information communications device or various electronic products and output it, thus stabilizing the flow of electricity within the circuits. A general capacitor has a very short charging and discharging time and a high output density, but because it has a low energy density, it has limitations in being used as an energy storage device.

Thus, in order to overcome such limitations of a general capacitor, recently, a novel capacitor, such as an electrical double layer capacitor (EDLC) having a high output density while having a short charging and discharging time, has been developed, which has drawn a great deal of attention as a next-generation energy device along with a secondary battery.

Also, recently, diverse electrochemical capacitors, whose operating principles are based on similar principles to those of an ELDC, have been developed, and an energy storage device called a hybrid capacitor, formed by combining the power storage principles of a lithium ion secondary battery and the ELDC, has come into prominence. As a hybrid capacitor, a lithium ion capacitor possessing both the high energy density of a secondary battery and the high output characteristics of an ELDC has recently been drawing attention.

As for the lithium ion capacitor, a negative electrode (i.e., a cathode), allowing for the occlusion and separation of lithium ions, comes into contact with a lithium metal so that lithium ions are occluded (or, doped) into the negative electrode by using a chemical or electro-chemical method in advance. Thus, the negative-electrode potential is lowered to thereby increase withstand voltage and remarkably increase energy density.

### SUMMARY OF THE INVENTION

An aspect of the present invention provides an electrolyte for a lithium ion capacitor, which has high capacitance and stability even at high temperature, and a lithium ion capacitor including the same.

According to an aspect of the present invention, there is provided an electrolyte for a lithium ion capacitor, the electrolyte including: a lithium salt expressed by chemical formula 1 below:

Li₂A (Chemical formula 1)

The lithium salt may be lithium fluoroborate expressed by chemical formula 2 below:

Li₂B₁₀FₓZ₁₀₋ₓ (Chemical formula 2)

where, x denotes a constant of between 1 and 10, and Z denotes H, Cl, Br or OR wherein R denotes H, fluoroalkyl or alkyl having a carbon number of between 1 and 8.

The lithium salt is lithium fluoroborate expressed by chemical formula 3 below:

Li₂B₁₂FₓZ₁₂₋ₓ (chemical formula 3)

where, x denotes a constant of between 1 and 12, and Z denotes H, Cl, Br or OR wherein R denotes H, fluoroalkyl or alkyl having a carbon number of between 1 and 8.

The lithium salt may be Li₂B₁₀F₁₀ or Li₂B₁₂F₁₂.

A content of the lithium salt may range from 0.1 mol/L to 20 mol/L.

The electrolyte may include a solvent selected from the group consisting of ethylene carbonate, propylene carbonate, fluoroethylene carbonate, diethyl carbonate, and butylene carbonate.

According to another aspect of the present invention, there is provided a lithium ion capacitor including: a first electrode formed of an electrode material capable of reversibly carrying lithium ions; a second electrode opposing the first electrode; a separation film placed between the first and second electrodes; and an electrolyte with which the first electrode, the second electrode and the separation film are impregnated, the electrolyte comprising a lithium salt expressed by chemical formula 1 below:

Li₂A (Chemical formula 1)

The lithium salt may be lithium fluoroborate expressed by chemical formula 2 below:

Li₂B₁₀FₓZ₁₀₋ₓ (Chemical formula 2)

where, x denotes a constant of between 1 and 10, and Z denotes H, Cl, Br or OR wherein R denotes H, fluoroalkyl or alkyl having a carbon number of between 1 and 8.

The lithium salt may be lithium fluoroborate expressed by chemical formula 3 below:

Li₂B₁₂FₓZ₁₂₋ₓ (chemical formula 3)

where, x denotes a constant of between 1 and 12, and Z denotes H, Cl, Br or OR wherein R denotes H, fluoroalkyl or alkyl having a carbon number of between 1 and 8.

The lithium salt may be Li₂B₁₀F₁₀ or Li₂B₁₂F₁₂.

A content of the lithium salt may range from 0.1 mol/L to 20 mol/L.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic cross-sectional view illustrating a lithium ion capacitor according to an exemplary embodiment of the present invention;

FIG. 2 is an exploded perspective view illustrating a cell of a lithium ion capacitor, according to an exemplary embodiment of the present invention; and

FIG. 3 is a schematic view illustrating the process of forming an electric double layer according to an exemplary embodiment of the present invention.

### DETAILED DESCRIPTION OF THE PREFERRED EMBODIMENT

Exemplary embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and sizes of elements may be exaggerated for clarity. Like reference numerals in the drawings denote like elements.

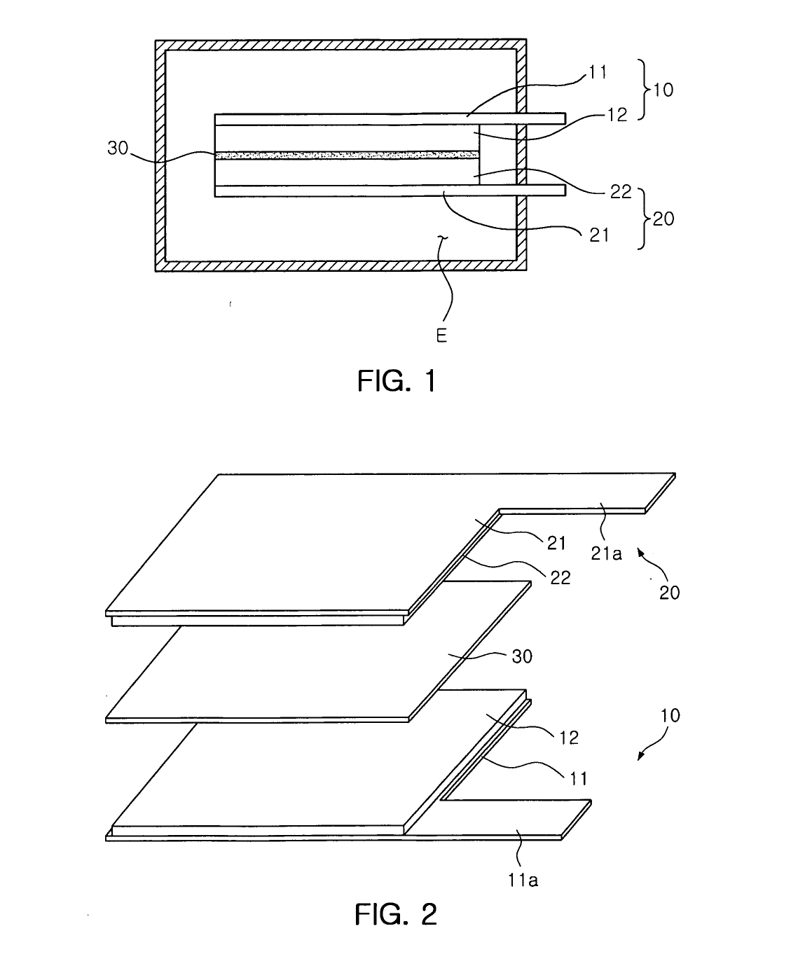

FIG. 1 is a schematic cross-sectional view illustrating a lithium ion capacitor according to an exemplary embodiment of the present invention. FIG. 2 is an exploded perspective view illustrating a capacitor cell of the lithium ion capacitor. Referring to FIGS. 1 and 2, the lithium ion capacitor, according to this exemplary embodiment of the present invention, includes a first electrode 10 and a second electrode 20 opposing each other, a separation film 30 placed between the first and second electrodes 10 and 20, and an electrolyte E, with which the first electrode 10, the second electrode 20 and the separation film 30 are impregnated.

Electricity of different polarities is applied to the first and second electrodes 10 and 20. In order to obtain desired capacitance, a plurality of first and second electrodes may be stacked.

According to this exemplary embodiment of the present invention, the first electrode 10 may be set to be a cathode (i.e., a negative electrode), and the second electrode 20 may be set to be an anode (i.e., a positive electrode).

The first electrode 10 may be prepared by forming a first electrode material 12 on a first conductive sheet 11.

As the first electrode material 12, a material capable of reversibly carrying lithium ions may be used. For example, a carbon material such as graphite, hard carbon or coke, a polyacene-based material, or the like may be used as the electrode material 12, but the present invention is not limited thereto.

Furthermore, the first electrode 10 may be formed of a mixture of the first electrode material 12 and a conductive material. The conductive material, although not limited thereto, may utilize acetylene black, graphite, metal powder or the like.

The first electrode material 12 may have a thickness of between 15 μM and 100 μm for example, but it is not limited thereto.

The first conductive sheet 11 delivers an electrical signal to the first electrode material 12, and serves as a current collector for collecting accumulated electrical charges. The first conductive sheet 11 may be formed as a metallic foil or a conductive polymer or the like. The metallic foil may be made of stainless steel, copper, nickel, or the like.

The first conductive sheet 11 may include a lead part 11a on which the first electrode material 12 is not placed. Electricity may be applied to the first electrode 10 through the lead part 11a.

Although not shown, the first electrode material 12 may be manufactured in the form of a solid sheet so as to be used as the first electrode 10, without using the first conductive sheet 11.

Since the first electrode 10 is pre-doped with Li ions, the potential thereof may be reduced to almost 0V. Accordingly, the potential difference between the first electrode 10 and the second electrode 20 increases to thereby enhance the energy density and output characteristics of a lithium ion capacitor.

The second electrode 20 may be provided by forming a second electrode material 22 on a second conductive sheet 21.

The second electrode material 22 may utilize, for example, an active carbon or a mixture of the active carbon, a conductive material and a binder, but it is not particularly limited.

The second electrode material 22 may have a thickness of between 15 μm and 100 μm for example, but is not particularly limited thereto.

The second conductive sheet 21 delivers an electrical signal to the second electrode material 22 and serves as a current collector for collecting accumulated electrical charges. The second conductive sheet 21 may be formed as a metallic foil or a conductive polymer. The metallic foil may be made of aluminum, stainless steel, or the like.

The second conductive sheet 21 may include a lead part 21a on which the second electrode material 22 is not placed. Electricity may be applied to the second electrode 20 through the lead part 21a.

Although not shown, the second electrode material 22 may be manufactured in the form of a solid sheet so as to be used as the second electrode 20, without using the second conductive sheet 21.

The separation film 30 may be disposed between the first electrode 10 and the second electrode 20 in order to electrically insulate the first and second electrodes 10 and 20. The separation film 30 may be made of a porous material allowing ions to be transmitted therethrough. For example, the porous material may be polypropylene, polyethylene, glass fiber, or the like.

The electrolyte E may employ an electrolyte for a lithium ion capacitor according to an exemplary embodiment of the present invention.

The electrolyte, according to this exemplary embodiment of the present invention, may include a lithium salt expressed by chemical formula 1 below:

Li₂A (Chemical formula 1)

where, A is a divalent anion binding to two Li cations.

In more detail, the electrolyte according to this exemplary embodiment of the present invention may include one or more lithium salts selected from the group consisting of lithium fluoroborate compounds expressed by chemical formulas 2 and 3 below:

Li₂B₁₀FₓZ₁₀₋ₓ (Chemical formula 2)

where, x denotes a constant of between 1 and 10, and Z denotes H, Cl, Br or OR wherein R denotes H, fluoroalkyl or alkyl having a carbon number of between 1 and 8.

Li₂B₁₂FₓZ₁₂₋ₓ (chemical formula 3)

where, x denotes a constant of between 1 and 12, and Z denotes H, Cl, Br or OR wherein R denotes H, fluoroalkyl or alkyl having a carbon number of between 1 and 8.

A specific example of the lithium fluoroborate compounds may be Li₂B₁₀F₁₀ or Li₂B₁₂F₁₂.

In general, as an electrolyte for a lithium ion capacitor, a lithium salt such as LiPF₆, LiBF₄, LiClO₄, LiN(SO₂CF₃)₂, LiN(SO₂C₂F₅)₂, LiPF₃(CF₃)₃, LiPF₅(CF₃) or the like has been utilized.

However, this exemplary embodiment is characterized by using a lithium salt including divalent anions. When this lithium salt is dissociated by a solvent, two lithium ions per divalent anion are generated.

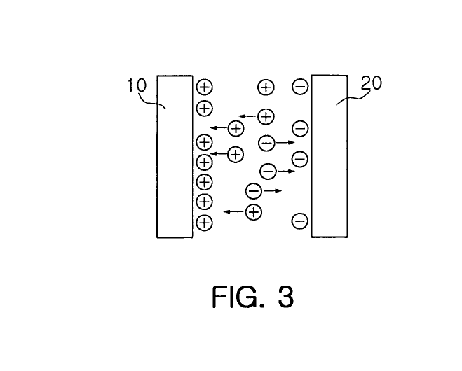

FIG. 3 is a schematic view illustrating the process of forming an electric double layer according to an exemplary embodiment of the present invention.

Referring to FIG. 3, when electricity is applied to the first and second electrodes 10 and 20, the first and second electrodes 10 and 20 are polarized into an anode and a cathode, respectively, and anions and cations within the electrolyte are attracted to the opposing surfaces of the first and second electrodes 10 and 20, thereby forming an electric double layer.

That is, dissociated lithium ions (+) are attracted to the cathode, that is, the first electrode 10, and divalent anions are attracted to the anode, thereby forming an electric double layer.

According to this exemplary embodiment of the present invention, the number of cations generated per mole is increased and thus, the capacitance of the lithium ion capacitor can be increased.

Furthermore, the divalent fluoroborate-based anions have higher oxidative resistance than lithium salts used in the related art, and can thus maintain stable performance even at high temperatures.

The concentration of the lithium salt is not particularly limited, provided that it is high enough to maintain the electro-conductivity of the electrolyte. For example, the concentration of the lithium salt may range from 0.1 mol/L to 20 mol/L.

A solvent of the electrolyte for a lithium ion capacitor, according to the exemplary embodiment of the present invention, is not particularly limited, and may utilize one that is generally used in the related art.

For example, the solvent, although not limited thereto, may be ethylene carbonate (EC), propylene carbonate (PC), fluoroethylene carbonate, diethyl carbonate (DEC), butylene carbonate or the like. Also, a mixture of one or more of the aforementioned materials may be used as the solvent.

Hereinafter, the present invention will now be described in more detail with reference to an inventive example and a comparative example.

### Inventive Example

Graphite available on the market was used to manufacture a cathode (i.e., a negative electrode). In detail, graphite, acetylene black and polyethylene vinylidene fluoride were mixed at a weight ratio of 80:10:10. The resultant mixture was added to N-Methylpyrrolidone acting as a solvent, which was then agitated to thereby obtain a slurry. The slurry was applied to a copper foil, having a thickness of 10 μm, by using a doctor blade method and was then dried. Thereafter, the resultant structure was processed to have an electrode area of 100 mm×100 mm, and was dried in a vacuum at 120° C. for 5 hours before a cell assembly process.

Meanwhile, active carbon powder, acetylene black and polyethylene vinylidene fluoride were mixed at a weight ratio of 80:10:10. The resultant mixture was added to N-Methylpyrrolidone acting as a solvent, which was then agitated to thereby obtain a slurry. The slurry was applied to an aluminum foil, having a thickness of 20 μm, by using a doctor blade method, and was then dried. Thereafter, the resultant structure was processed to have an electrode area of 100 mm×100 mm, and was dried in a vacuum at 120° C. for 10 hours before the cell assembly process.

Li₂B₁₂F₁₂ was dissolved into a solvent, a mixture of EC, PC and DEC (3:1:2 wt %) to have a concentration of 0.6 mol/L, thereby preparing an electrolyte.

A separation film (polypropylene non-woven fabric) was inserted between the cathode and the anode prepared in the above manner and was then impregnated with the electrolyte, and thereafter, the resultant capacitor cell was put into an accommodation case made of a laminate film and then sealed. The sealed cell was left as it was for about one day before measuring.

### Comparative example

A capacitor cell was manufactured in the same manner as in the above inventive example, except that LiPF₆ was used in this comparative example.

The laminate type cells prepared by the inventive example and the comparative example were evaluated electro-chemically. The evaluation result revealed that higher capacitance and stability at high temperatures were obtained in the case of the inventive example using Li₂B₁₂F₁₂ as an electrolyte, rather than in the case of the comparative example using LiPF₆ as an electrolyte.

As set forth above, according to exemplary embodiments of the invention, an electrolyte for a lithium ion capacitor contains a lithium salt including divalent anions. Since this lithium salt contributes to increasing the number of cations generated per mole to thereby increase the capacitance of the lithium ion capacitor.

Furthermore, the lithium salt has high oxidative resistance, thereby maintaining stable performance even at high temperature.

While the present invention has been shown and described in connection with the exemplary embodiments, it will be apparent to those skilled in the art that modifications and variations can be made without departing from the spirit and scope of the invention as defined by the appended claims.

What is claimed is:

1. An electrolyte for a lithium ion capacitor, the electrolyte comprising:
a lithium salt expressed by chemical formula 1 below:
Li₂A (Chemical formula 1)

2. The electrolyte of claim 1, wherein the lithium salt is lithium fluoroborate expressed by chemical formula 2 below:
Li₂B₁₀FₓZ₁₀₋ₓ (Chemical formula 2)
where, x denotes a constant of between 1 and 10, and Z denotes H, Cl, Br or OR wherein R denotes H, fluoroalkyl or alkyl having a carbon number of between 1 and 8.

3. The electrolyte of claim 1, wherein the lithium salt is lithium fluoroborate expressed by chemical formula 3 below:
Li₂B₁₂FₓZ₁₂₋ₓ (chemical formula 3)
where, x denotes a constant of between 1 and 12, and Z denotes H, Cl, Br or OR wherein R denotes H, fluoroalkyl or alkyl having a carbon number of between 1 and 8.

4. The electrolyte of claim 1, wherein the lithium salt is Li₂B₁₀F₁₀ or Li₂B₁₂F₁₂.

5. The electrolyte of claim 1, wherein a content of the lithium salt ranges from 0.1 mol/L to 20 mol/L.

6. The electrolyte of claim 1, wherein the electrolyte comprises a solvent selected from the group consisting of ethylene carbonate, propylene carbonate, fluoroethylene carbonate, diethyl carbonate, and butylene carbonate.

7. A lithium ion capacitor comprising:
a first electrode formed of an electrode material capable of reversibly carrying lithium ions;
a second electrode opposing the first electrode;
a separation film placed between the first and second electrodes; and
an electrolyte with which the first electrode, the second electrode and the separation film are impregnated, the electrolyte comprising a lithium salt expressed by chemical formula 1 below:
Li₂A (Chemical formula 1)

8. The lithium ion capacitor of claim 7, wherein the lithium salt is lithium fluoroborate expressed by chemical formula 2 below:
Li₂B₁₀FₓZ₁₀₋ₓ (Chemical formula 2)
where, x denotes a constant of between 1 and 10, and Z denotes H, Cl, Br or OR wherein R denotes H, fluoroalkyl or alkyl having a carbon number of between 1 and 8.

9. The lithium ion capacitor of claim 7, wherein the lithium salt is lithium fluoroborate expressed by chemical formula 3 below:
Li₂B₁₂FₓZ₁₂₋ₓ (chemical formula 3)
where, x denotes a constant of between 1 and 12, and Z denotes H, Cl, Br or OR wherein R denotes H, fluoroalkyl or alkyl having a carbon number of between 1 and 8.

10. The lithium ion capacitor of claim 7, wherein the lithium salt is L₁₂B₁₀F₁₀ or Li₂B₁₂F₁₂.

11. The lithium ion capacitor of claim 7, wherein a content of the lithium salt ranges from 0.1 mol/L to 20 mol/L.
